(19) United States
(12) Patent Application Publication
(10) Pub. No.: US 2024/0346557 A1
(43) Pub. Date: Oct. 17, 2024

(54) FAIR AND TRUSTED RATING OF MODELS AND/OR ANALYTICS SERVICES IN A COMMUNICATION NETWORK SYSTEM

(71) Applicant: Nokia Technologies Oy, Espoo (FI)

(72) Inventors: Dario BEGA, Munich (DE); Anja JERICHOW, Grafing bei München (DE); Saurabh KHARE, Bangalore (IN); Konstantinos SAMDANIS, Munich (DE); Colin KAHN, Morris Plains, NJ (US); Gerald KUNZMANN, Munich (DE)

(21) Appl. No.: 18/701,065

(22) PCT Filed: Oct. 13, 2021
(86) PCT No.: PCT/EP2021/078283

§ 371 Date: Apr. 12, 2024

(51) Int. Cl. G06Q 30/0282

(52) U.S. Cl. CPC G06Q 30/0282

(57) ABSTRACT

A trusted rating function in a communication network system obtains at least one verification information associated with at least one of an analytics function identifier, a service identifier and a service consumer identifier, receives, from a service consumer, rating information related to at least one rated service and consumer verification information associated with the service consumer, accepts the rating information based on a comparison between the obtained verification information and the consumer verification information, and updates a rating stored for the rated service based on the rating information.

### TECHNICAL FIELD

At least some example embodiments relate to fair and trusted rating of models and/or analytics services in a communication network system.

### BACKGROUND

Artificial Intelligence (AI) and Machine Learning (ML) techniques are being increasingly employed in 5G system (5GS) and will continue to play an important role in 6G as well. NWDAF in 5G core (5GC) and MDAF for OAM are two logical elements standardized by 3GPP in the 5GS that bring intelligence and generate analytics by processing management and control plane network data and may employ AI and ML techniques.

3GPP working groups SA2 (see e.g. TS 23.288) and SA5 (see e.g. TS 28.533) are working on the integration of AI/ML models for analytics production.

In a mobile network, multiple AI/ML models and/or multiple NWDAFs or MDAF producers providing the analytics for the same purpose may be available.

### LIST OF ABBREVIATIONS

3GPP Third Generation Partnership Project
5G Fifth Generation
5GC 5G Core
5GS 5G System
6G Sixth Generation
AI/ML Artificial Intelligence/Machine Learning
AnLF Analytics Logical Function
AOI Area Of Interest
API Application Programming Interface
MDAF Management Data Analytics Function (exposing one or multiple MDAS(s))
MDAS Management Data Analytics Service
MTLF Model Training Logical Function
NRF Network Repository Function
NWDAF Network Data Analytics Function
OAM Operations, Administration and Maintenance
SA Service and System Aspects
TRF Trusted Rating Function

### SUMMARY

According to at least some example embodiments, a framework is introduced, the framework enabling a trusted and fair rating of AI/ML models and/or services (which are referred to here also as analytics services) that produce analytics provided by different producers or by same producer offering in this case multiple AI/ML models for the same service. For example, analytics producers are NWDAFs, MDAFs, where it is possible that the functions/services are provided from different vendors.

According to at least some example embodiments, a service consumer is enabled to select the most suitable (e.g., the best one in terms of performance for the required use case/scenario) AI/ML model and/or analytics service producer among the available ones, while a vendor and/or service producer is able to exploit rating information to improve its own solution and/or as a benchmark when designing a novel algorithm.

According to at least some example embodiments, apparatuses, methods and non-transitory computer-readable storage media are provided as specified by the appended claims.

In particular, according to at least some example embodiments, a Trusted Rating Function (TRF) that manages the rating provided by the consumers is provided. For example, the TRF stores and updates the ratings.

Furthermore, according to at least some example embodiments, the TRF ensures that only “real” consumers (i.e., consumers that really had access to the model and/or service) can rate the AI/ML model and/or service that produced the analytics. For example, the TRF prevents rating (of its own) by the producer of the AI/ML model and/or analytics service while an analytics consumer from the same vendor is still able to rate the analytics service, while such rating, for example, is treated differently (e.g. gets a lower weighting compared to other ratings when the different ratings are aggregated into a single value). For example, an NWDAF(MTLF) that has produced a model is forbidden to rate the model, while an NWDAF(AnLF) from the same vendor is able to rate the model if the model is used by the NWDAF(AnLF).

According to at least some example embodiments, the TRF is co-located with existing repositories such as NRF or UDM/UDR, or management plane service discovery repositories.

According to at least some example embodiments, the TRF has its own managed database.

According to at least some example embodiments, moreover, a rating format that includes key information regarding the usage of the analytics service which, for example, is provided using an AI/ML model, and that can be exploited by other consumers as well as by other producers/vendors is introduced.

According to at least some example embodiments, in addition, a framework to enable the rating of AI/ML models and/or services that produce analytics, and the selection of the best, in terms of performance, AI/ML model and/or service producer available is introduced.

In case there are multiple AI/ML models and/or analytics, i.e., statistics or predictions, for different producers (such as NWDAF, MDAF) providing services producing similar analytics, at least some example embodiments provide for mechanisms to allow a consumer to select the algorithm/model/producer which provides the best performance, e.g. for a specific use case/scenario, based on a trusted and fair rating scheme.

According to at least some example embodiments, fair rating is provided even in a multi-vendor scenario.

Furthermore, according to at least some example embodiments, an AI/ML algorithm is associated with the scenario on which the model has been tested and evaluated.

It is noted that the term “AI/ML model” as used in this application may apply to a raw ML model (e.g. architecture+model weights), as well as an application/service employing such AI/ML model.

In the following some example embodiments will be described with reference to the accompanying drawings.

### BRIEF DESCRIPTION OF THE DRAWINGS

FIG. 1A shows a flowchart illustrating a process of providing a trusted rating function according to at least some example embodiments.

FIG. 1B shows a flowchart illustrating a process of applying a trusted rating function according to at least some example embodiments.

FIG. 2 shows a signaling diagram illustrating signaling in a trusted rating framework applied for an analytics consumer rating an analytics service provided by an NWDAF(AnLF) according to at least some example embodiments.

FIG. 3 shows a signaling diagram illustrating signaling in a trusted rating framework applied for an NWDAF(AnLF) rating an AI/ML model provided by an NWDAF(MTLF) according to at least some example embodiments.

FIG. 4 shows a table illustrating a rating format according to at least some example embodiments.

FIG. 5 shows a schematic block diagram illustrating a configuration of a control unit in which at least some example embodiments are implementable.

FIG. 6A shows a flowchart illustrating a process of providing a trusted rating function according to at least some example embodiments.

FIG. 6B shows a flowchart illustrating a process of applying a trusted rating function according to at least some example embodiments.

FIG. 6C shows a flowchart illustrating a process of providing trusted rating according to at least some example embodiments.

### DESCRIPTION OF THE EMBODIMENTS

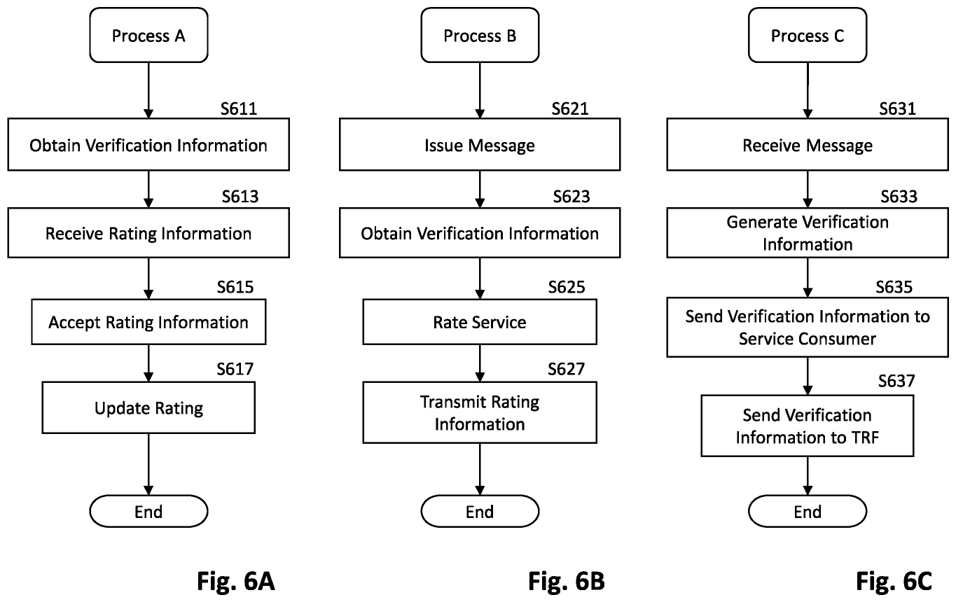

Before exploring details of example embodiments of a trusted rating function (TRF), a rating format and a framework for trusted rating, reference is made to FIGS. 6A, 6B and 6C illustrating processes related to trusted rating according to at least some example embodiments.

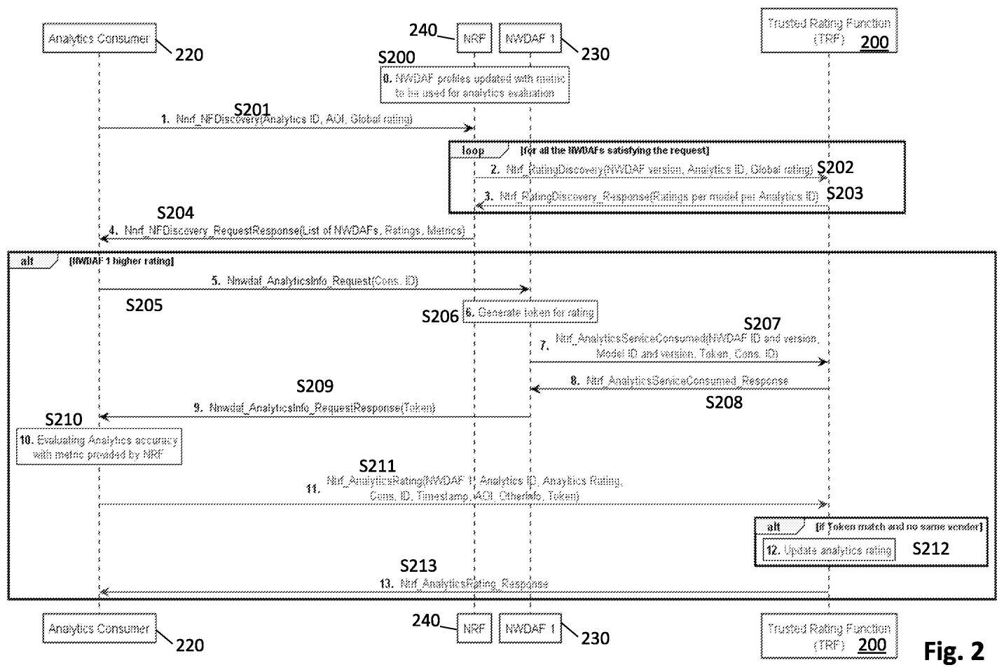

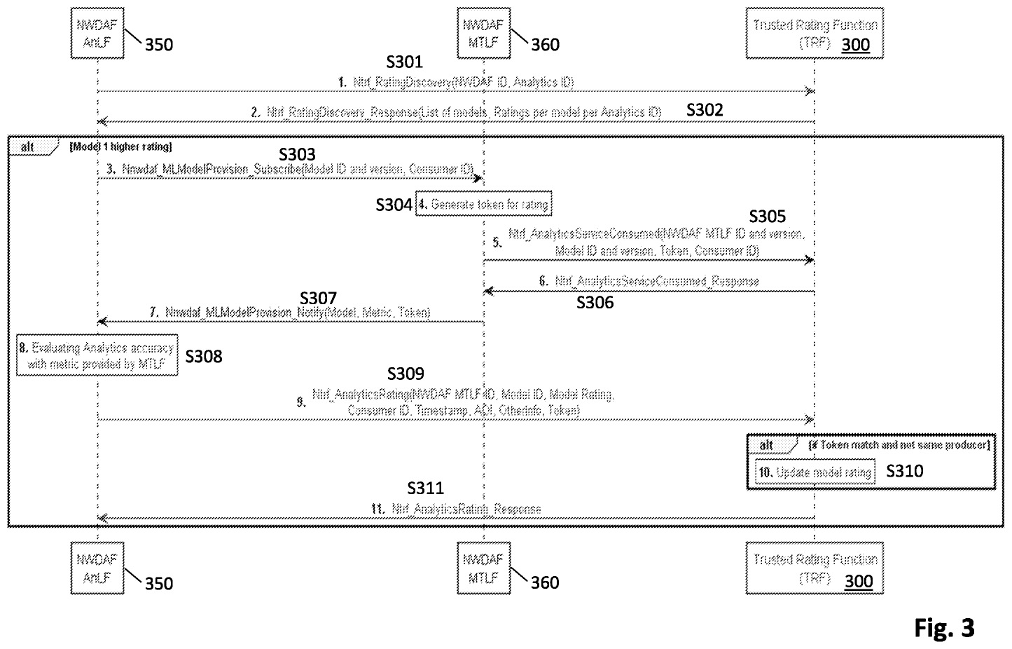

FIG. 6A shows a flowchart illustrating a process A of a trusted rating function according to at least some example embodiments. According to an example implementation, the process A is executed by a TRF (e.g. TRF 200 of FIG. 2, TRF 300 of FIG. 3).

According to at least some example embodiments, functionality of the TRF is implemented as a new NF.

According to at least some example embodiments, functionality of the TRF is implemented as part of the existing NWDAF.

According to at least some example embodiments, functionality of the TRF is implemented as part of existing NRF.

According to at least some example embodiments, functionality of the TRF is implemented as part of any other NF.

In step S611, at least one verification information associated with at least one of an analytics function identifier, a service identifier and a service consumer identifier is obtained. According to at least some example embodiments, step S611 corresponds to step S207 of FIG. 2 and/or step S305 of FIG. 3.

In step S613, from a service consumer, rating information related to at least one rated service and consumer verification information associated with the service consumer are received. According to at least some example embodiments, step S613 corresponds to step S211 of FIG. 2 and/or step S309 of FIG. 3.

In step S615, the rating information is accepted based on a comparison between the obtained verification information and the consumer verification information.

In step S617, a rating stored for the rated service is updated based on the rating information. Then process A ends.

According to at least some example embodiments, steps S615 and S617 correspond to step S212 of FIG. 2 and/or step S310 of FIG. 3.

According to at least some example embodiments, the obtained at least one verification information includes a first identification identifying a service producer and the consumer verification information includes a second identification identifying the service consumer, wherein, in step S615, the rating information is accepted if the first identification is different from the second identification.

According to at least some example embodiments, the obtained at least one verification information includes first information identifying the service consumer and the rated service (e.g. a token for rating as described in more detail with reference to FIGS. 2 and 3 later on) and the consumer verification information includes second information identifying the service consumer and the rated service, wherein, in step S615, the rating information is accepted if the first information matches the second information.

Now reference is made to FIG. 6B which shows a flowchart illustrating a process B of applying a trusted rating function according to at least some example embodiments. According to an example implementation, the process B is executed by a service consumer (e.g. analytics consumer 220 of FIG. 2) or an NWDAF AnLF (e.g. NWDAF AnLF 350 of FIG. 3).

In step S621, a message requesting an analytics function to provide a service is issued and, as a service consumer identifier, an identifier of the service consumer is included in the message.

According to at least some example embodiments, step S621 corresponds to step S205 of FIG. 2 and/or step S303 of FIG. 3.

In step S623, in response to the message, verification information associated with at least one of the service consumer identifier, a service identifier identifying the service and an analytics function identifier identifying the analytics function is obtained.

According to at least some example embodiments, step S623 corresponds to step S209 of FIG. 2 and/or step S307 of FIG. 3.

In step S625, the service is rated.

According to at least some example embodiments, step S625 corresponds to step S210 of FIG. 2 and/or step S308 of FIG. 3.

In step S627, rating information related to the rated service and consumer verification information which is associated with the service consumer and the obtained verification information is transmitted to a trusted rating function. Then process B ends.

According to at least some example embodiments, step S627 corresponds to step S211 of FIG. 2 and/or step S309 of FIG. 3.

According to at least some example embodiments, the consumer verification information includes at least one of an identification identifying the apparatus as a service consumer, and information identifying the service consumer and the rated service.

According to at least some example embodiments, the service is rated based on metrics information provided by the analytics function.

Now reference is made to FIG. 6C which shows a flowchart illustrating a process C of applying a trusted rating according to at least some example embodiments. According to an example implementation, the process C is executed by a service producer (e.g. NWDAF1 230 of FIG. 2, NWDAF MTLF 360 of FIG. 3).

In step S631, a message requesting the apparatus to provide a service is received, the message including a service consumer identifier identifying a service consumer.

According to at least some example embodiments, step S631 corresponds to step S205 of FIG. 2 and/or step S303 of FIG. 3.

In step S633, verification information associated with at least one of an analytics function identifier identifying the apparatus, a service identifier identifying the service and the service consumer identifier is generated.

According to at least some example embodiments, step S633 corresponds to step S206 of FIG. 2 and/or step S304 of FIG. 3.

In step S635, the generated verification information is sent to the service consumer.

According to at least some example embodiments, step S635 corresponds to step S209 of FIG. 2 and/or step S307 of FIG. 3.

In step S637, the verification information is sent to a trusted rating function. Then process C ends.

According to at least some example embodiments, step S637 corresponds to step S207 of FIG. 2 and/or step S305 of FIG. 3.

According to at least some example embodiments, the verification information includes at least one of an identification identifying the service producer and information identifying the service consumer and the service.

According to at least some example embodiments, the service comprises at least one of an analytics and a model, and the service identifier identifies at least one of the analytics and the model.

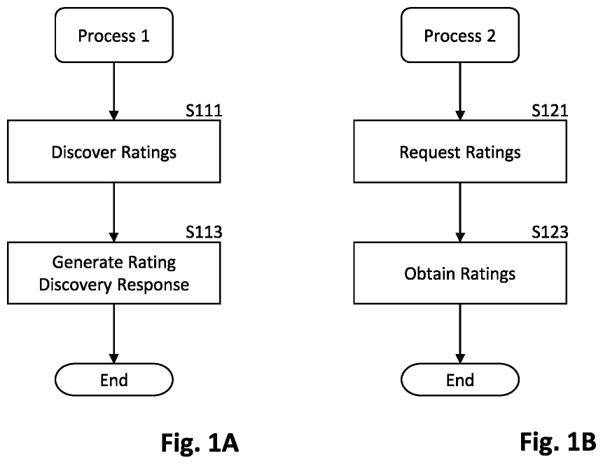

Now reference is made to FIGS. 1A and 1B illustrating processes related to trusted rating according to at least some example embodiments.

FIG. 1A shows a flowchart illustrating a process 1 of a trusted rating function according to at least some example embodiments. According to an example implementation, the process 1 is executed by a TRF (e.g. TRF 200 of FIG. 2, TRF 300 of FIG. 3).

According to at least some example embodiments, functionality of the TRF is implemented as a new NF.

According to at least some example embodiments, functionality of the TRF is implemented as part of the existing NWDAF.

According to at least some example embodiments, functionality of the TRF is implemented as part of existing NRF.

According to at least some example embodiments, functionality of the TRF is implemented as part of any other NF.

According to at least some example embodiments, process 1 is started when a rating discovery request is received by the TRF as depicted e.g. in steps S201, S202 of FIG. 2 and step S301 of FIG. 3, which will be described in more detail later on.

When process 1 is started, process 1 proceeds to step S111 in which, based on the rating discovery request, ratings of at least one service identified by a service identifier and being provided by one or more analytics functions is discovered. Then process 1 proceeds to step S113.

In step S113, a rating discovery response is generated. The rating discovery response is generated by including the ratings. Then, process 1 ends.

Implementation examples of the rating discovery response are shown by steps S203, S204 of FIG. 2 and step S302 of FIG. 3, which will be described in more detail later on.

According to at least some example embodiments, the rating discovery response further includes an identifier list identifying the one or more analytics functions.

According to at least some example embodiments, the rating discovery response alternatively or in addition includes an identifier list identifying models that produce the analytics associated with the service.

According to at least some example embodiments, the analytics function identifier identifies, out of one or more analytics functions, a certain analytics function using a certain model or providing the service for producing analytics.

According to at least some example embodiments, the rating is stored based on a rating format, wherein the rating format comprises at least one of the following:
a time (e.g. “timestamp”) when the rated service has been rated (e.g. a model and/or analytics has been evaluated),
a service identifier identifying the rated service provided by an analytics function (e.g. a model identifier (e.g. “model ID”) identifying the model used by the analytics function to produce the analytics),
a version of the rated service (e.g. a version of the model),
an analytics identifier (e.g. “analytics ID”) identifying the analytics associated with the rated service,
a rating (e.g. “rating/quality indicator”) of the rated service (e.g. model or analytics),
a consumer identifier (e.g. “consumer ID”) identifying the consumer that is rating the rated service (e.g. model or analytics),
an analytics function identifier (e.g. “NWDAF ID”) identifying the analytics function,
a version of the analytics function (e.g. “version of NWDAF software”),
issue information (e.g. “Issue”) related to potential problems encountered when relying on the analytics produced by the rated service (e.g. model),
geographical area information (e.g. “Geographical Area”) related to one or more areas of interest for which the analytics service has been provided (e.g. in which the model has been used),
environment condition information (e.g. “Environment Condition”) related to conditions of the network communication system when the rated service has been provided (e.g. the model has been used,
user condition information (e.g. “User(s) Condition”) related to a state of a user involved in the analytics, and
service condition information (e.g. “Service Condition”) related to an adopted service.

Now reference is made to FIG. 1B which shows a flowchart illustrating a process 2 of applying a trusted rating function according to at least some example embodiments. According to an example implementation, the process 2 is executed by a service consumer (e.g. analytics consumer 220 of FIG. 2) or an NWDAF AnLF (e.g. NWDAF AnLF 350 of FIG. 3). For example, process 2 is started when the analytics consumer or NWDAF AnLF looks for NWDAFs providing a specific service, e.g. in a specified AOI.

When process 2 is started, process 2 proceeds to step S121 in which, by a rating discovery request (e.g. step S201 of FIG. 2, step S301 of FIG. 3), ratings of at least one service being provided by one or more analytics functions is requested. Then process 2 proceeds to step S123.

In step S123, from a rating discovery response (e.g. step S204 of FIG. 2, step S302 of FIG. 3), the ratings are obtained. Then process 2 ends.

According to at least some example embodiments, in step S123, from the rating discovery response, an identifier list identifying the one or more analytics functions is obtained.

According to at least some example embodiments, alternatively or in addition, in step S123, from the rating discovery response, an identifier list identifying models that produce an analytics associated with the service is obtained.

According to at least some example embodiments, in step S123, from the rating discovery response, metrics to be used to rate the service are obtained.

According to at least some example embodiments, accuracy of the service is evaluated by using the metrics (e.g. in step S210 of FIG. 2, step S308 of FIG. 3).

In the following, example embodiments of the trusted rating function, rating format and framework for trusted rating will be described in more detail by referring to FIGS. 2 to 4.

FIG. 2 illustrates a trusted rating framework applied to an analytics consumer 220 rating a service (also referred to in the following as analytics service) provided by an NWDAF(AnLF) (NWDAF1) 230 according to at least some example embodiments.

As shown by S200, one or several NWDAFs (e.g. including NWDAF1 230) update their profiles at an NRF 240 to include a metric to be utilized to rate an AI/ML model and/or a service that produce analytics requested. According to at least some example embodiments, a metric is provided for each AI/ML model and/or analytics, i.e., a metric is associated to each model—analytics couple.

In S201, the analytics consumer 220 sends a discovery request to NRF 240 looking for NWDAFs providing a specific Analytics ID in a specified AOI. The analytics consumer 220 sets a “Global rating” flag to True in case it is interested to receive an aggregated model rating, while to False in case it is interested to receive a detailed model rating per consumer.

For example, the aggregated rating is e.g. a value between 0 (very bad performance) to 5 (very good performance) derived by a (possibly weighted) average over all ratings. Along with the aggregated rating, the analytics consumer 220 receives also the total number of ratings submitted, so that the analytics consumer 220 is able to derive the trustworthiness of the rating.

In step S202, the NRF 240 collects for all the NWDAFs satisfying the request (i.e. the NWDAFs that support the Analytics ID for the requested AOI) the rating(s) of the employed model(s) (aggregated rating in case the “Global rating” flag is set to True) stored at a Trusted Rating Function (TRF) 200 through an Ntrf_RatingDiscovery service. The NRF 240 specifies the NWDAF version and the Analytics ID. The rating is collected per model ID and per analytics ID.

According to at least some example embodiments, the TRF 200 is co-located with or hosted by NRF 240 or a UDM for discovery. If the analytics consumer 220 queries the UDM to discover the analytics function, then the UDM will perform the operations executed here by NRF 240.

According to at least some example embodiments, the NRF 240 has implemented a local cache for such ratings, in order to avoid the need to query the TRF 200 for each NWDAF discovery request.

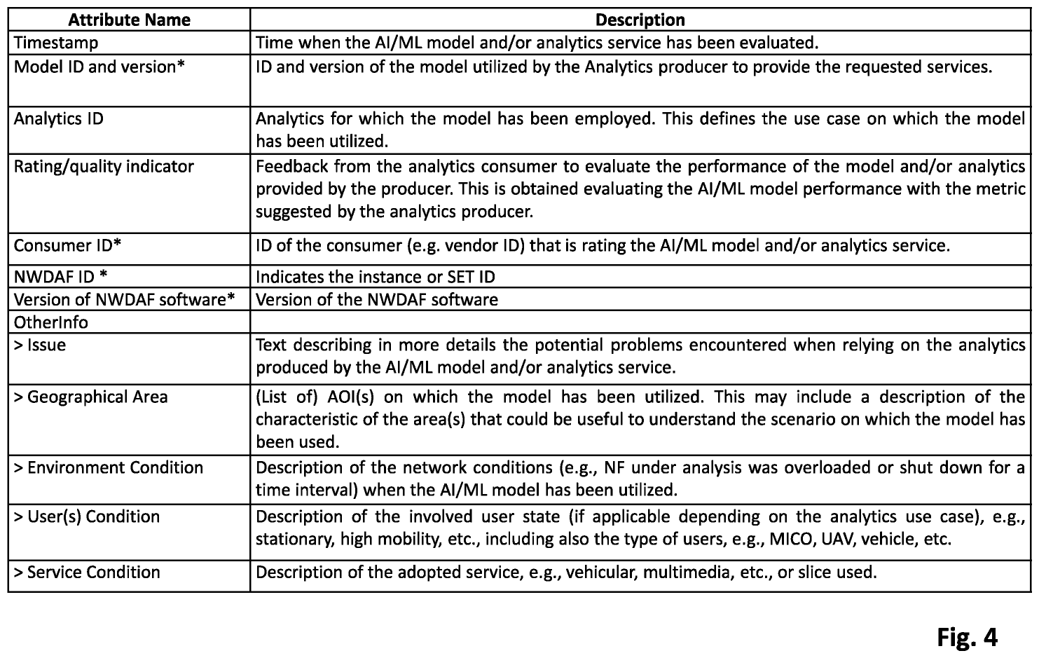

In step S203, the TRF 200 returns to the NRF 240 the required ratings if available. It includes global rating (e.g., weighted average rating from all the analytics consumers) as well as a rating per vendor (e.g. average rating per analytics consumer) e.g. for a specific use case/scenario. In this way, the analytics consumer 220 is enabled to identify potential unfair ratings. Further details about the rating format will be described with reference to FIG. 4 later on.

According to at least some example embodiments, the services utilized in steps S202-203 are used by a vendor when designing a new solution for a particular Analytics ID. The vendor downloads the ratings of the available solutions and uses them as a benchmark during its own design phase. Furthermore, the vendor is enabled to also access ratings of its own models to evaluate their performance and update them if needed.

In step S204, the NRF 240 forwards the list of available NWDAFs matching the filter parameters along with the ratings and the metrics to the analytics consumer 220.

In step S205, the analytics consumer 220 selects the NWDAF1 230 providing the best performance for the specific use case and scenario. The analytics consumer 220 requests the analytics service to the selected NWDAF1 230 specifying also its Consumer ID (e.g., the ID to identify the vendor).

In step S206, the NWDAF1 230 generates a token that can be used by the analytics consumer 220 to rate the analytics service and/or the AI/ML model. The token may be an example of verification information that is used to decide whether rating information is accepted or not as described below.

In step S207, the NWDAF1 230 sends through an Ntrf_AnalyticsServiceConsumed service to the TRF 200 information about the Consumer ID, Model ID and version used for producing the analytics, its NWDAF ID and version and the token generated for the analytics consumer 220. In this way, the TRF 200 is enabled to associate the rating from the analytics consumer 220 to the analytics service provided by the NWDAF1 230 and the AI/ML model and/or service used to generate it (in case the analytics service is based on an AI/ML model).

In step S208, the TRF 200 sends an acknowledgement to the NWDAF1 230.

In step S209, the NWDAF1 230 sends the analytics response to the analytics consumer 220 along with the token generated for allowing only “real” consumers (i.e., only the ones that really have consumed the service) to evaluate the AI/ML model and/or analytics service.

It is to be noted that in case the analytics consumer 220 subscribes to the analytics service, the token is valid for the entire subscription duration and the consumer is able to update its rating re-using the token. Once the subscription is terminated, the NWDAF1 230 informs the TRF 200 about it, such that only a final rating can be provided by the consumer after which the token is revoked.

In step S210, the analytics consumer 220 evaluates the performance of the AI/ML model and/or analytics service utilizing the metric obtained by the NRF 240 during the discovery procedure.

In step S211, the analytics consumer 220 through an Ntrf_AnalyticsRating service sends its rating (also referred to here as rating information) to the TRF 200. The analytics consumer 220 specifies among others the Consumer ID. In this way, the TRF 200 is enabled to store the rating also per consumer. The analytics consumer 220 also sends the received token to the TRF 200.

In S212, the TRF 200, in case the token matches and the analytics consumer 220 is not the model producer, accepts and updates the rating. According to at least some example embodiments, an analytics consumer from the same vendor of the solution utilized for providing the analytics service is able to rate the analytics service and the used model, while the entity producing/exposing the model is not allowed to rate it. For example, an analytics consumer from the same vendor of the NWDAF(AnLF) producer can rate the analytics service (utilizing a model provided by the MTLF) while ratings from the NWDAF(AnLF) and NWDAF(MTLF) producers are not accepted. The TRF 200 stores the rating per model ID per Analytics ID and for each Consumer ID. In case the analytics service is not AI/ML model based, the model ID is left blank in the rating stored at the TRF 200.

In step S213, the TRF 200 sends to the analytics consumer 220 a confirmation regarding the update of the rating.

According to at least some example embodiments, an analytics consumer rates an analytics service provided by an analytics producer. The analytics are produced by leveraging on AI/ML model and/or traditional services. The analytics consumer may not be aware that an AI/ML model has been employed to produce the analytics requested (for privacy reasons especially in a multi-vendors scenario the analytics producer may want to hide this information). Thus, the rating is related to the Analytics ID. This also allows, in the case an AI/ML model is employed, to relate the AI/ML model performance with the scenario on which it has been utilized. This information is useful for the analytics producer, and it can be also exploited by the analytics consumer in case it is allowed to access it.

FIG. 3 illustrates a trusted rating framework applied to NWDAF(AnLF) 350 rating an AI/ML model provided by NWDAF(MTLF) 360 according to at least some example embodiments.

In step S301, the NWDAF(AnLF) 350 sends an Ntrf_RatingDiscovery request to a TRF 300, for collecting ratings of models providing a specific Analytics ID.

In step S302, the TRF 300 returns to the NWDAF(AnLF) 350 the required ratings if available in an Ntrf_RatingDiscovery_Response including a list of models providing the specific Analytics ID and ratings per model per Analytics ID.

In step S303, the NWDAF(AnLF) 350 subscribes to the NWDAF(MTLF) 360 providing a model (model 1) selected by the NWDAF(AnLF) 350 based on the ratings obtained from the TRF 300, by sending an Nnwdaf_MLModelProvision_Subscribe request including Model ID and version and Consumer ID (e.g. identifier of the NWDAF(AnLF) 350).

In step S304, the NWDAF(MTLF) 360 generates a token for rating by the NWDAF(AnLF) 350.

In step S305, the NWDAF(MTLF) 360 sends an Nrf_AnalyticsServiceConsumed Request to the TRF 300 including NWDAF MTLF ID and version, the Model ID and version, the token and the Consumer ID.

In step S306, the TRF 300 returns an Ntrf_AnalyticsServiceConsumed_Response similarly as in step S208 of FIG. 2.

In step S307, the NWDAF(MTLF) 360 sends an Nnwdaf_MLModelProvision_Notify message to the NWDAF(AnLF) 350, the message comprising information on the certain model or the certain model itself, metric to be used to rate the certain model and the token generated in step S304.

In step S308, the accuracy of the model is e.g. evaluated by the NWDAF(AnLF) 350 using the metric(s) provided by the MWDAF(MTLF) 360 and some benchmarking data.

In step S309, the NWDAF(AnLF) 350 sends an Ntrf_AnalyticsRating request to the TRF 300, the request comprising the MWDAF MTLF ID, Model ID, Model Rating (also referred to here as rating information), Consumer ID, Timestamp, AOI, OtherInfo and the token.

In step S310, if the token matches and the NWDAF(AnLF) 350 is not the producer/provider of the rated model, the TRF 300 updates the model rating based on the received rating information.

In step S311, the TRF 300 sends to the NWDAF(AnLF) 350 a confirmation regarding the update of the ratings, similarly as in step S213 of FIG. 2.

According to at least some example embodiments, in case a trusted rating framework is employed as part of 3GPP SA5 scenario, for the management plane an MDAF (providing Management Data Analytics Service (MDAS)) that takes the role of an NWDAF and an NRF is an equivalent management plane discovery repository. Alternatively, if the management plane contains no repository, then the discovery is performed in two steps. The analytics consumer initially enquires a DNS to get the IP address of an MDAS producer and then it requests explicitly from that specific MDAS producer to discover its analytics capabilities. In this case the TRF is a logical function inside the MDA producer that provides an indication to the MDAS consumer, regarding the rating and the corresponding metrics of the supporting AI/ML models.

In the following, the rating format stored at the TRF 200, 300 according to at least some example embodiments will be described in more detail by referring to FIG. 4.

The rating format as illustrated by the table shown in FIG. 4 stores attributes Timestamp, Model ID and version, Analytics ID, Rating/quality indicator, Consumer ID, NWDAF ID, Version of NWDAF software.

Further, the rating format stores further information called “OtherInfo”, including Issue, Geographical Area, Environment Condition, User(s) Condition, Service Condition.

In “Timestamp”, a time when the AI/ML model and/or analytics service has been evaluated is stored.

In “Model ID and version”, ID and version of the model utilized by the analytics producer to provide the requested services are stored. In case no model is utilized for producing the analytics, this attribute is left blank.

According to at least some example embodiments, the combination of the model (e.g. model ID and version) and the analytics function (e.g. NWDAF) is the subject of the rating.

According to at least some example embodiments, the combination of the analytics ID and the analytics function is the subject of the rating.

According to at least some example embodiments, the combination of the analytics ID and the model ID (e.g. model ID and version) and the analytics function is the subject of the rating.

In “Analytics ID”, analytics for which the model has been employed is stored. This defines the use case on which the model has been utilized.

In “Rating/quality indicator”, feedback from the analytics consumer to evaluate the performance of the model and/or analytics provided by the analytics producer is stored. For example, the feedback is obtained by the analytics consumer evaluating the AI/ML model performance with the metric suggested by the analytics producer.

In “Consumer ID”, the ID of the consumer (e.g. vendor ID) that is rating the AI/ML model and/or analytics service is stored.

In “NWDAF ID”, the instance or Set ID of the analytics service is stored.

In “Version of NWDAF software”, the version of the NWDAF software is stored.

In “Issue”, text describing in more detail potential problems encountered when relying on the analytics produced by the AI/ML model and/or analytics service is stored.

In “Geographical Area”, (a list of) AOI(s) on which the model has been utilized is/are stored. For example, this includes a description of the characteristic of the area(s) that could be useful to understand the scenario on which the model has been used.

In “Environment Condition”, description of network conditions (e.g., NF under analysis was overloaded or shut down for a time interval) when the AI/ML model has been utilized is stored.

In “User(s) Condition”, description of an involved user state (if applicable depending on the analytics use case), e.g., stationary, high mobility, etc., including also the type of users, e.g., MICO, UAV, vehicle, etc. is stored.

In “Service Condition”, description of an adopted service, e.g., vehicular, multimedia, etc., or slice used is stored.

The attributes marked with * in FIG. 4 are forwarded to the TRF 200, 300 by the NWDAF in step S207 of FIG. 2 and step S305 of FIG. 3. The rest of the attributes is provided by the analytics consumer as part of the rating in step S211 of FIG. 2 and step S309 of FIG. 3.

As described above, according to at least some example embodiments, AI/ML model producers are enabled to leverage on ratings for both performance monitoring of a model or as a benchmark at the moment of building a new model or (re-)training an existing model for a specific use case.

Case 1—Monitoring: an AI/ML model producer periodically downloads the rating of its AI/ML model from the TRF utilizing the Ntrf_RatingDiscovery service using the Model ID instead of the Analytics ID. Alternatively, the AI/ML producer subscribes with the TRF to receive notifications, e.g. in case the rating of the model falls below a given threshold. In this way, the AI/ML model producer is enabled to monitor the ratings received for its model and improve or update (e.g. re-train) the model in case performance degradation is detected or if the model does not work as expected in particular use cases.

Case 2—Benchmark: an AI/ML model producer is interested in knowing the ratings of existing AI/ML models for a particular Analytics service. The model producer downloads from the TRF the ratings of all the models utilized for the requested Analytics ID and without specifying any NWDAF ID and/or version in the Ntrf_RatingDiscovery service. If the AI/ML model producer is allowed to get access to the AI/ML model ratings, the TRF will forward them to it. The AI/ML model producer can then utilize the ratings as benchmark to evaluate its solution during design time.

According to at least some example embodiments, an OAM API is designed to manage the ratings or update (e.g. remove) stale ratings.

According to at least some example embodiments, ratings are provided and used by consumers and producers in a fair manner even across different vendors.

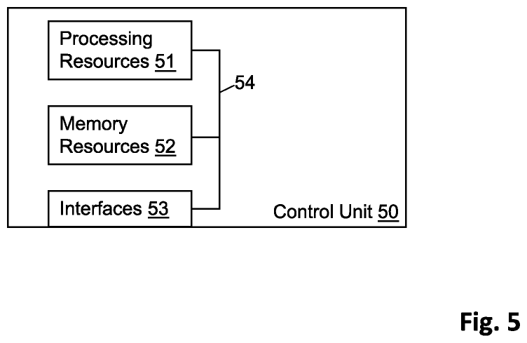

Now reference is made to FIG. 5 illustrating a simplified block diagram of a control unit 50 that is suitable for use in practicing at least some example embodiments. According to an implementation example, the processes of FIGS. 1A-C are implemented by control units each being similar to the control unit 50.

The control unit 50 comprises processing resources (e.g. processing circuitry) 51, memory resources (e.g. memory circuitry) 52 and interfaces (e.g. interface circuitry) 53, which are coupled via a wired or wireless connection 54.

According to an example implementation, the memory resources 52 are of any type suitable to the local technical environment and are implemented using any suitable data storage technology, such as semiconductor based memory devices, magnetic memory devices and systems, optical memory devices and systems, fixed memory and removable memory. The processing resources 51 are of any type suitable to the local technical environment, and include one or more of general purpose computers, special purpose computers, microprocessors, digital signal processors (DSPs) and processors based on a multi core processor architecture, as non limiting examples.

According to an implementation example, the memory resources 52 comprise one or more non-transitory computer-readable storage media which store one or more programs that when executed by the processing resources 51 cause the control unit 50 to function as TRF, analytics consumer or analytics producer (or model producer/provider) as described above.

Further, as used in this application, the term “circuitry” refers to one or more or all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

According to at least some example embodiments, an apparatus for providing a trusted rating function in a communication network system is provided. The apparatus comprises
means for obtaining at least one verification information associated with at least one of an analytics function identifier, a service identifier and a service consumer identifier;
means for receiving from a service consumer rating information related to at least one rated service and consumer verification information associated with the service consumer;
means for accepting the rating information based on a comparison between the obtained verification information and the consumer verification information, and
means for updating a rating stored for the rated service based on the rating information.

According to at least some example embodiments, the obtained at least one verification information includes a first identification identifying a service producer and the consumer verification information includes a second identification identifying the service consumer,
wherein the apparatus further comprises
means for accepting the rating information if the first identification is different from the second identification.

According to at least some example embodiments, the obtained at least one verification information includes first information identifying the service consumer and the rated service and the consumer verification information includes second information identifying the service consumer and the rated service,
wherein the apparatus further comprises
means for accepting the rating information if the first information matches the second information.

According to at least some example embodiments, the apparatus further comprises
means for, based on a rating discovery request, discovering ratings of at least one service identified by a service identifier and being provided by one or more analytics functions; and
means for generating a rating discovery response including the ratings.

According to at least some example embodiments, the rating discovery response further includes at least one of
an identifier list identifying the one or more analytics functions, and
an identifier list identifying models that produce an analytics associated with the service.

According to at least some example embodiments, the analytics function identifier identifies, out of one or more analytics functions, a certain analytics function using a certain model or providing the service for producing analytics.

According to at least some example embodiments, the apparatus further comprises:
means for storing the rating based on a rating format, wherein the rating format comprises at least one of the following:
   a time when the rated service has been rated,
   a service identifier identifying the rated service provided by an analytics function,
   a version of the rated service,
   an analytics identifier identifying an analytics associated with the rated service,
   a rating of the rated service,
   a consumer identifier identifying the service consumer that is rating the rated service,
   an analytics function identifier identifying the analytics function,
   a version of the analytics function,
   issue information related to potential problems encountered when relying on the analytics produced by the rated service,
   geographical area information related to one or more areas of interest for which the rated service has been provided,
   environment condition information related to conditions of the network communication system when the rated service has been provided,
   user condition information related to a state of a user involved in the analytics, and
   service condition information related to an adopted service.

According to at least some example embodiments, the rated service comprises at least one of an analytics and a model, and the service identifier identifies at least one of the analytics and the model.

According to at least some example embodiments, an apparatus for applying trusted rating in a communication network system is provided. The apparatus comprises:
means for issuing a message requesting an analytics function to provide a service, and including, as a service consumer identifier, an identifier of the apparatus in the message;
means for, in response to the message, obtaining verification information associated with at least one of the service consumer identifier, a service identifier identifying the service and an analytics function identifier identifying the analytics function;
means for rating the service; and
means for transmitting rating information related to the rated service and consumer verification information which is associated with the apparatus and the obtained verification information, to a trusted rating function.

According to at least some example embodiments, the means for rating the service comprises means for rating the service based on metrics information provided by the analytics function.

According to at least some example embodiments, the apparatus further comprises
means for requesting, by a rating discovery request, ratings of at least one service being provided by one or more analytics functions; and
means for obtaining the ratings from a rating discovery response.

According to at least some example embodiments, apparatus further comprises:
means for obtaining, from the rating discovery response, at least one of:
an identifier list identifying the one or more analytics functions, and
an identifier list identifying models that produce an analytics associated with the service.

According to at least some example embodiments, an apparatus for providing trusted rating in a communication network system is provided. The apparatus comprises:
means for receiving a message requesting the apparatus to provide a service, the message including a service consumer identifier identifying a service consumer;
means for generating verification information associated with at least one of an analytics function identifier identifying the apparatus, a service identifier identifying the service and the service consumer identifier;
means for sending the generated verification information to the service consumer; and
means for sending the verification information to a trusted rating function.

According to at least some example embodiments, the verification information includes at least one of an identification identifying the apparatus as a service producer and information identifying the service consumer and the service.

It is to be understood that the above description is illustrative and is not to be construed as limiting. Various modifications and applications may occur to those skilled in the art without departing from the true spirit and scope as defined by the appended claims.

1.-31. (canceled)

32. An apparatus for providing a trusted rating function in a communication network system, the apparatus comprising at least one processor and at least one memory including computer program code, the at least one memory and the computer program code configured to, with the at least one processor, cause the apparatus at least to:
obtain verification information associated with an analytics function identifier, a service identifier, and a service consumer identifier, the verification information comprising a token for an analytics consumer to rate an analytics service and an artificial intelligence (AI) and machine learning (ML) model;
send information about a consumer identification (ID), model ID, and version used for producing an analytics service, a Network Data Analytics Function (NWDAF) ID and version, and the token generated for the analytics consumer to enable an association between a rating from the analytics consumer to the analytics service and the AI and ML model and service used to generate it;
receive, from a service consumer, rating information related to a performance of the analytics service and the AI and ML model and consumer verification information associated with the service consumer;
accept the rating information based on a comparison between the obtained verification information and the consumer verification information to enable the service consumer from a same vendor of a solution utilized for providing the analytics service to rate the analytics service and the AI and ML model while not enabling an entity that produces the AI and ML model or the analytics service to rate the analytics service or the AI and ML model; and
store, in a ratings format, the rating information for the analytics service and the AI and ML model, the ratings format comprising: a time when the analytics service has been rated, a service identifier identifying the analytics service provided by an analytics function, a version of the analytics service, an analytics identifier identifying analytics associated with the analytics service, a rating of the analytics service, a consumer identifier identifying the service consumer that is rating the analytics service, an analytics function identifier identifying the analytics function, a version of the analytics function, issue information related to potential problems encountered when relying on the analytics produced by the analytics service, geographical area information related to one or more areas of interest for which the analytics service has been provided, environment condition information related to conditions of the network communication system when the analytics service has been provided, user condition information related to a state of a user involved in the analytics, and service condition information related to an adopted service.

33. The apparatus of claim 32, wherein the obtained at least one verification information includes a first identification identifying a service producer and the consumer verification information includes a second identification identifying the service consumer,
wherein the at least one memory and the computer program code are configured to, with the at least one processor, cause the apparatus to:
accept the rating information if the first identification is different from the second identification.

34. The apparatus of claim 33, wherein the obtained at least one verification information includes first information identifying the service consumer and the rated service and the consumer verification information includes second information identifying the service consumer and the rated service,
wherein the at least one memory and the computer program code are configured to, with the at least one processor, cause the apparatus to:
accept the rating information if the first information matches the second information.

35. The apparatus of claim 34, wherein the at least one memory and the computer program code are configured to, with the at least one processor, cause the apparatus further to:
based on a rating discovery request, discover ratings of at least one service identified by a service identifier and being provided by one or more analytics functions; and
generate a rating discovery response including the ratings.

36. The apparatus of claim 35, the rating discovery response further including at least one of
an identifier list identifying the one or more analytics functions, and
an identifier list identifying models that produce an analytics associated with the service.

37. The apparatus of claim 36, wherein the analytics function identifier identifies, out of a plurality of analytics functions, a certain analytics function using a certain model or providing the service for producing analytics.

38. The apparatus of claim 37, wherein the analytics service comprises the analytics service and the AI and ML model, and the service identifier identifies the analytics service and the AI and ML model.

39. A system comprising:
an apparatus for providing a trusted rating function in a communication network system, the apparatus comprising:
at least one processor; and
at least one non-transitory computer-readable medium comprising computer-executable instructions that, when executed by the at least one processor, cause the at least one processor to perform the following operations:
obtain verification information associated with an analytics function identifier, a service identifier, and a service consumer identifier, the verification information comprising a token for an analytics consumer to rate an analytics service and an artificial intelligence (AI) and machine learning (ML) model;
send information about a consumer identification (ID), model ID, and version used for producing an analytics service, a Network Data Analytics Function (NWDAF) ID and version, and the token generated for the analytics consumer to enable an association between a rating from the analytics consumer to the analytics service and the AI and ML model and service used to generate it;
receive, from a service consumer, rating information related to a performance of the analytics service and the AI and ML model and consumer verification information associated with the service consumer;
accept the rating information based on a comparison between the obtained verification information and the consumer verification information to enable the service consumer from a same vendor of a solution utilized for providing the analytics service to rate the analytics service and the AI and ML model while not enabling an entity that produces the AI and ML model or the analytics service to rate the analytics service or the AI and ML model; and
store, in a ratings format, the rating information for the analytics service and the AI and ML model, the ratings format comprising: a time when the analytics service has been rated, a service identifier identifying the analytics service provided by an analytics function, a version of the analytics service, an analytics identifier identifying analytics associated with the analytics service, a rating of the analytics service, a consumer identifier identifying the service consumer that is rating the analytics service, an analytics function identifier identifying the analytics function, a version of the analytics function, issue information related to potential problems encountered when relying on the analytics produced by the analytics service, geographical area information related to one or more areas of interest for which the analytics service has been provided, environment condition information related to conditions of the network communication system when the analytics service has been provided, user condition information related to a state of a user involved in the analytics, and service condition information related to an adopted service.

40. The system of claim 39, wherein the obtained at least one verification information includes a first identification identifying a service producer and the consumer verification information includes a second identification identifying the service consumer; and
wherein the computer-executable instructions further cause the at least one processor to perform the following operation:
accept the rating information if the first identification is different from the second identification.

41. The system of claim 40, wherein the obtained at least one verification information includes first information identifying the service consumer and the analytics service and the consumer verification information includes second information identifying the service consumer and the analytics service,
wherein the computer-executable instructions further cause the at least one processor to perform the following operation:
accept the rating information if the first information matches the second information.

42. The system of claim 41, wherein the computer-executable instructions further cause the at least one processor to perform the following operations:
based on a rating discovery request, discover ratings of at least one service identified by a service identifier and being provided by one or more analytics functions; and
generate a rating discovery response including the ratings.

43. The system of claim 42, the rating discovery response further including:
an identifier list identifying the one or more analytics functions, and
an identifier list identifying models that produce an analytics associated with the service.

44. The system of claim 43, wherein the analytics function identifier identifies, out of a plurality of analytics functions, a certain analytics function using a certain model or providing the service for producing analytics.

45. The system of claim 44, wherein the analytics service comprises the analytics service and the AI and ML model, and the service identifier identifies the analytics service and the AI and ML model.

46. A method for providing a trusted rating function in a communication network system, the method comprising:
obtaining verification information associated with an analytics function identifier, a service identifier, and a service consumer identifier, the verification information comprising a token for an analytics consumer to rate an analytics service and an artificial intelligence (AI) and machine learning (ML) model;
sending information about a consumer identification (ID), model ID, and version used for producing an analytics service, a Network Data Analytics Function (NWDAF) ID and version, and the token generated for the analytics consumer to enable an association between a rating from the analytics consumer to the analytics service and the AI and ML model and service used to generate it;
receiving, from a service consumer, rating information related to a performance of the analytics service and the AI and ML model and consumer verification information associated with the service consumer;
accepting the rating information based on a comparison between the obtained verification information and the consumer verification information to enable the service consumer from a same vendor of a solution utilized for providing the analytics service to rate the analytics service and the AI and ML model while not enabling an entity that produces the AI and ML model or the analytics service to rate the analytics service or the AI and ML model; and
storing, in a ratings format, the rating information for the analytics service and the AI and ML model, the ratings format comprising: a time when the analytics service has been rated, a service identifier identifying the analytics service provided by an analytics function, a version of the analytics service, an analytics identifier identifying analytics associated with the analytics service, a rating of the analytics service, a consumer identifier identifying the service consumer that is rating the analytics service, an analytics function identifier identifying the analytics function, a version of the analytics function, issue information related to potential problems encountered when relying on the analytics produced by the analytics service, geographical area information related to one or more areas of interest for which the analytics service has been provided, environment condition information related to conditions of the network communication system when the analytics service has been provided, user condition information related to a state of a user involved in the analytics, and service condition information related to an adopted service.

47. The method of claim 46, wherein the obtained at least one verification information includes a first identification identifying a service producer and the consumer verification information includes a second identification identifying the service consumer; and
wherein the method further comprises accepting the rating information if the first identification is different from the second identification.

48. The method of claim 47, wherein the obtained at least one verification information includes first information identifying the service consumer and the analytics service and the consumer verification information includes second information identifying the service consumer and the analytics service; and
wherein the method further comprises accepting the rating information if the first information matches the second information.

49. The method of claim 48, further comprising:
based on a rating discovery request, discovering ratings of at least one service identified by a service identifier and being provided by one or more analytics functions; and
generating a rating discovery response including the ratings.

50. The method of claim 49, wherein the rating discovery response further includes an identifier list identifying the one or more analytics functions, and an identifier list identifying models that produce an analytics associated with the service.

51. The method of claim 50, wherein the analytics function identifier identifies, out of a plurality of analytics functions, a certain analytics function using a certain model or providing the service for producing analytics, and wherein the analytics service comprises the analytics service and the AI and ML model, and the service identifier identifies the analytics service and the AI and ML model.
